(19) United States
(12) Patent Application Publication
(10) Pub. No.: US 2022/0238889 A1
(43) Pub. Date: Jul. 28, 2022

(54) BATTERY AND METHOD OF MAKING A BATTERY

(71) Applicant: LIBERKOWSKI, Janusz B., Los Gatos, CA (US)

(72) Inventor: Janusz B. LIBERKOWSKI, Los Gatos, CA (US)

(21) Appl. No.: 17/626,301

(22) PCT Filed: Dec. 1, 2019
(86) PCT No.: PCT/US2019/063901

§ 371 Date: Jan. 11, 2022

Related U.S. Application Data
(60) Provisional application No. 62/921,867, filed on Jul. 11, 2019.

(51) Int. Cl. H01M 4/76; H01M 4/66; H01M 4/74; H01M 10/0525; H01M 4/48

(52) U.S. Cl. CPC H01M 4/765; H01M 4/661; H01M 2004/027; H01M 10/0525; H01M 4/48; H01M 4/74

(57) ABSTRACT

In a storage battery, a cathode comprises a wedge-shaped or cone-shaped housing containing SiO2 nanoparticles, wherein the wide portion of the wedge or cone includes one or more expansion regions or expansion devices.

### FIELD OF THE INVENTION

The invention relates to the field of batteries, inter alia Lithium Ion batteries.

### BACKGROUND OF THE INVENTION

Lithium Ion batteries have become the work horse for many energy storage systems, from lap top computers to electric motor vehicles. A typical Li Ion battery with a graphite anode (negative electrode) has high coulombic efficiency, good cycle performance, low internal resistance with low self-discharge, does not suffer from memory effect, has a wide operating voltage range, and a long life. However, it suffers from low energy capacity.

The anode plays a significant role in improving the performance of a Li Ion battery. Traditional graphite anodes have a specific capacity close to the theoretical value of 372 mA/g. Therefore, any attempt to increase the energy capacity requires that one consider using different materials.

One approach that has been investigated in the past is the use of different materials for the anode of the Li Ion battery. Silicon, with a theoretical capacity of 3590 mAh/g has almost a ten times higher theoretical capacity compared to graphite. Thus it would be a valuable material for use in the anode. However, it has several drawbacks. Firstly, it displays low electrical conductivity. Secondly, it suffers from large volume changes during cycling, which are of the order of 300%. And thirdly, because of the repeated volume changes, it displays instability of the SEI layer.

### SUMMARY OF THE INVENTION

The present invention is directed to addressing some of the challenges faced by the battery industry.

In particular, the present invention defines and describes a method and battery using alternative anode materials, while addressing the risk of an explosion or other breakdown of the battery during use.

In order to address the low conductivity of Silicon, the present invention makes use of Silicon Dioxide (SiO2) or other conductive forms of silicon.

Further, the energy capacity of the battery depends on the surface area of the anode and cathode. Hence, the present invention increases the surface area of the anode material by making use of particularized material or silicon-based material in powder form. This may comprise SiO2 powder, also referred to herein as SiO2 nanoparticles.

Electrolyte is interspersed between the SiO2 nanoparticles, and can be in liquid form, seeping in between the SiO2 nanoparticles when assembled, or can be in granular/powder form itself, in which case it can be interspersed between the SiO2 during manufacture.

According to the invention, there is provided a battery, e.g., a Lithium Ion battery, comprising an anode, a cathode, and a separator between the anode and the cathode, wherein the anode is made of particularized Silicon Dioxide (SiO2) and includes means for accommodating the expansion of the SiO2.

The SiO2 may comprise nanoparticles contained in one or more housings to define one or more anodes interspersed between multiple cathodes or formed within a cathode to form one or more cells of a battery. The anodes, each comprising SiO2 anode material retained in an anode housing, may be electrically connected to each other. The cathodes, which typically will be interspersed or otherwise placed in proximity with the anodes, may similarly be electrically connected to each other.

The cathode may comprise a solid cathode material shaped to define an anode housing. The cathode may be substantially cylindrical with a conical cavity for receiving granular anode material such as SiO2. An expansion region may be provided at the wide end of the conical cavity.

Each anode and each cathode may be electrically connected to a current collector, which in the case of the anode may be a copper mesh, and in the case of the cathode, may be an aluminum mesh. By choosing a particularized anode material (in this case SiO2), the anode material is not fixed to the current collector but remains in physical contact with the current collector even when the anodes expand or contract.

To ensure good electrical contact between the anode material and current collector, the anode material may be compressed in its anode housings.

The housings containing the SiO2 particles (also referred to herein as anode housings) may have angled walls. For example, the walls of each housing may define a wedge-shaped or cone-shaped anode housing.

The anode and cathode housings may be defined by a porous separator, e.g., a porous membrane between the anode housings and cathode housings. The anode and cathode housings may instead comprise individual structures that each includes a current collector. These anode and cathode housings may subsequently be assembled to form multiple cells of a battery. The anode housings and cathode housings may be alternatingly stacked together.

Each anode housing or group of anode housings may include an expansion region or may be connected to an expansion means. The expansion region may be integrally formed with the anode housing, or may form a separate housing in flow communication with the anode housing to allow SiO2 particles to flow into the expansion region or expansion means. The expansion region may include a cylindrical housing with a piston, or a housing with a flexible wall, e.g. a latex membrane, to accommodate expansion of SiO2 particles. The expansion means may also include a flexible membrane covering an opening in the anode housing. For ease of description, the various expansion regions, membranes, or bladders, will also be referred to herein generally as expansion means.

One or more expansion means are preferably located on the wide side of the wedge-shaped or cone-shaped anode housing(s).

### BRIEF DESCRIPTION OF THE DRAWINGS

FIG. 1 is a three-dimensional few of one embodiment of a set of anode housings of the present invention,

FIG. 2 shows a three-dimensional view of the anode housings of FIG. 1 and corresponding cathode housings that make up one embodiment of a Li Ion battery of the present invention,

FIG. 3 shows a three-dimensional view of the anode and cathode housings of FIG. 2 intermeshed to form one embodiment of a Li Ion battery of the present invention,

FIG. 4 shows a three-dimensional view of another embodiment of a Li Ion battery of the present invention,

FIG. 5, shows a three-dimensional view of the embodiment of FIG. 4 from a different direction,

FIG. 6, shows a three-dimensional view of part of the embodiment of FIG. 4,

FIG. 7 shows a three-dimensional view of a variation of the Li Ion battery embodiment of FIG. 4,

FIG. 8 shows a three-dimensional view of yet another embodiment of a Li Ion battery of the present invention,

FIG. 9, shows a detailed three-dimensional view of one end of the embodiment of FIG. 8,

FIG. 10, shows a three-dimensional view of the embodiment of FIG. 8 from the end depicted in FIG. 9, with the addition of expansion means,

FIG. 11, shows a three-dimensional view of the embodiment of FIG. 8 from the opposite direction of FIG. 9,

FIGS. 12-15 show parts of anode and cathode housings of the embodiment of FIG. 8;

FIG. 16 shows a three-dimensional sectional view of the embodiment of FIG. 8,

FIG. 17 shows a three-dimensional view of yet another embodiment of a Li Ion battery of the present invention, and

FIG. 18 shows a sectional side view of the embodiment of FIG. 17.

### DETAILED DESCRIPTION OF THE INVENTION

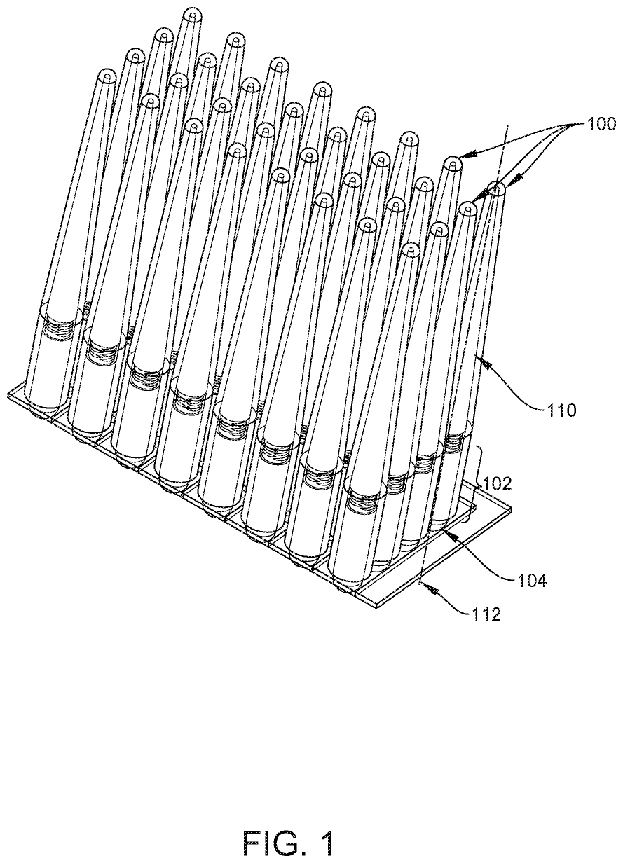

One embodiment of a Lithium Ion battery of the present invention is shown in FIGS. 1-3. FIG. 1 shows a matrix of anodes, each defined by a cone-shaped anode housing 100, terminating in an expansion region 102 and a flexible end cap 104. Particularized (granular) Silicon Dioxide (SiO2) 110 is used as the anode material, and is packed into the anode housings to ensure that the particles of SiO2 are conductively connected to each other.

By making use of a cone-shaped anode housing for each anode, any expansion of the SiO2 110 will cause it to be forced longitudinally downward in a direction along the longitudinal axis 112 of the cone-shaped housing 100. The expansion regions 102 in this embodiment are cylindrical sections housing a piston (not shown) that travels within the cylinder and allows the SiO2 to expand and contract.

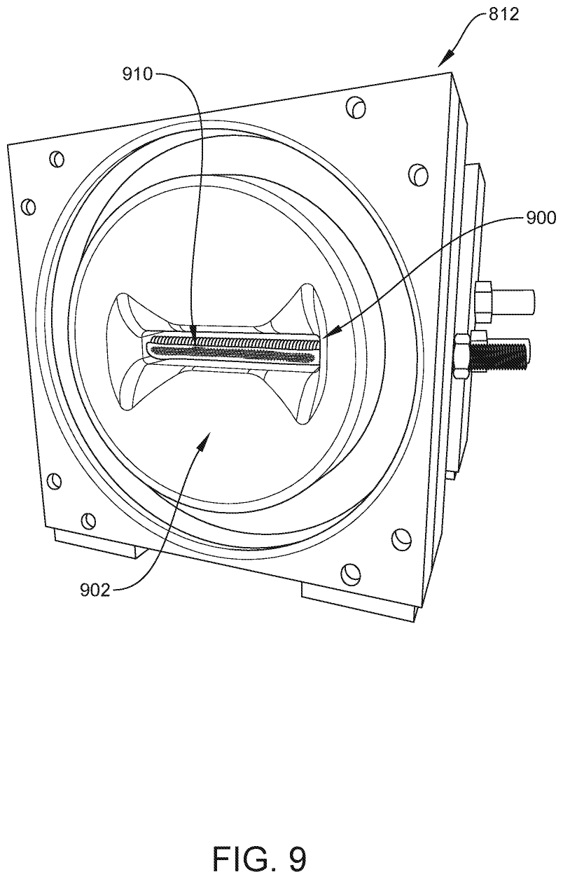

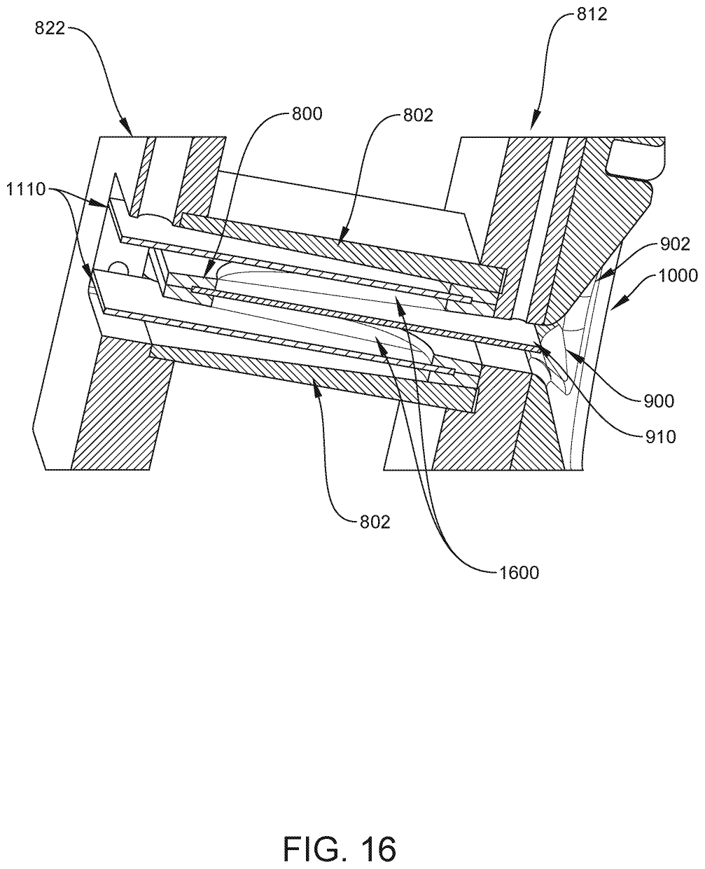

In order to electrically connect the anodes to a common negative electrode, each anode includes a current collector (not shown in this embodiment but discussed with respect to the embodiment of FIG. 9 and the embodiment of FIG. 16), which may take the form of a copper mesh, running longitudinally within the anode housing 100 along the longitudinal axis 112. Thus. any movement of the granular SiO2 material longitudinally will nevertheless maintain electrical contact with the current collector. The current collectors are in turn electrically connected together and connected to a negative electrode. The cathodes in the cathode housings are similarly provided with current collectors, e.g. Aluminum mesh, and connected to each other and a common positive electrode.

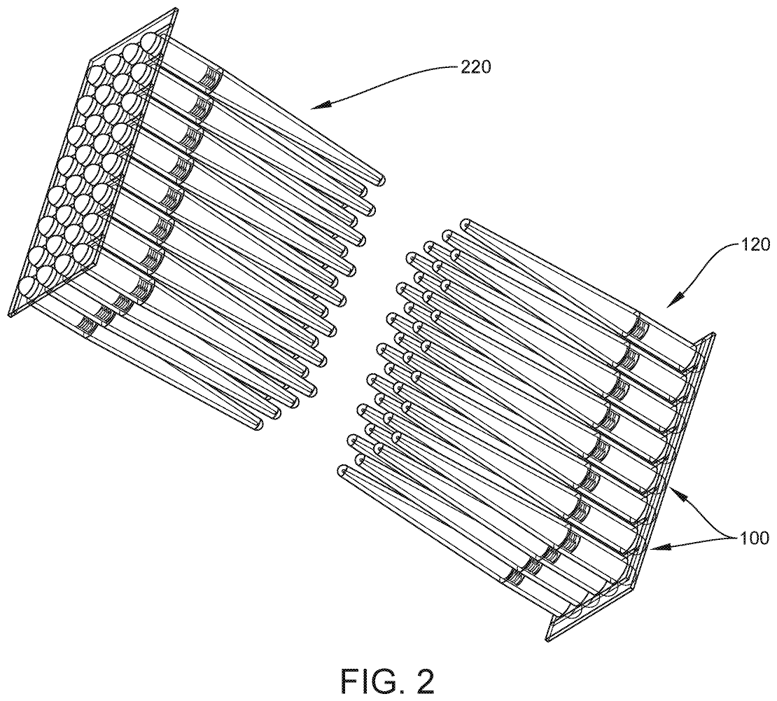

FIG. 2 shows the matrix of anode housings 100, depicted generally as the anode 120 of a battery prior to assembly. A corresponding matrix of cathode housings defines the cathode 220.

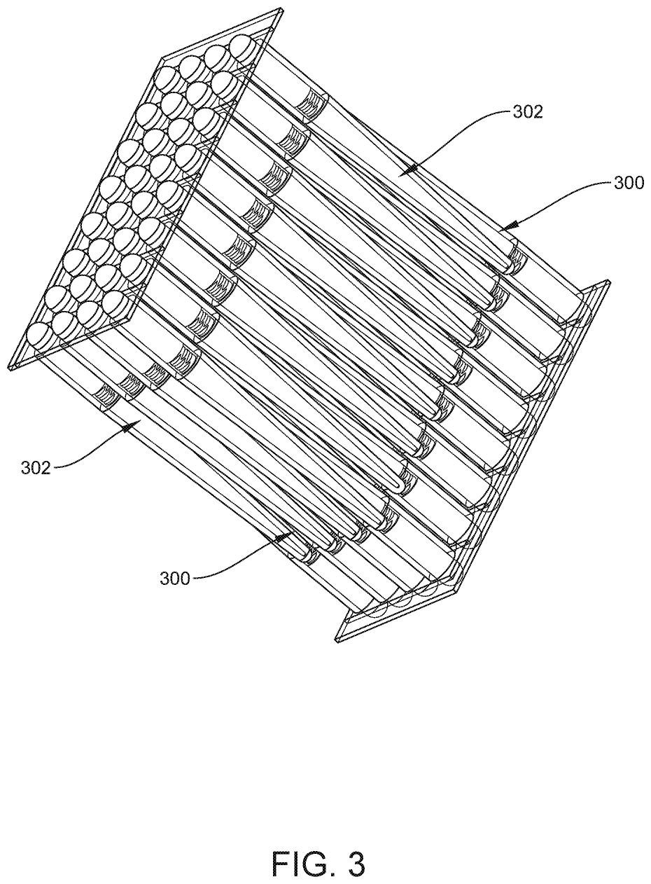

As shown in FIG. 3, the anode and cathode housings are staggered relative to each other allowing the two matrices (anode cells 300 and cathode cells 302) to slot together to define an anode-cathode matrix of interspersed anode cones and cathode cones, forming multiple cells of a battery.

The cone-shaped walls of the anode and cathode housings are made of a permeable material having tiny openings for ions to pass through but small enough to avoid the particulate SiO2 material of the anodes from seeping out through the cone-shaped walls of the anode housings. In embodiments where a liquid electrolyte is used for ion transport between the anodes and cathodes, the electrolyte seeps through the permeable housing walls of the anode and cathode housings to contact the individual nanoparticles of SiO2 in the anodes and the granular cathode particles in the cathodes. In embodiments where a granular solid is used for the electrolyte, electrolyte particles and anode particles are preferably mixed prior to packing the material into the anodes. Similarly, granular electrolyte and granular cathode material is mixed and packed into the cathodes.

It will be noted that the configuration of the cathode housings is similar to that described for the anode housings in this embodiment, however this is for convenience, compatibility, and ease of manufacturing. It will be appreciated that the cathode material typically does not expand, at least not to a significant degree. Hence the cone shape of the cathode housings is not for expansion purposes but to allow the anode and cathode cones to intersperse (mesh) when the anode cells 300, and cathode cells 302 are fitted together.

In practice, the two sections with the anode cells 300, and cathode cells 302 will be housed in a battery housing filled with an electrolyte (not shown). All of the anode elements (defined by the SiO2 in the anode housings 100) will be electrically connected to define the anode 120 of the battery, and are connected to a common negative electrode (not shown). Similarly, the cathode elements defined by the cathode material in the cathode housings, are electrically connected to define the cathode 220 of the battery, and are connected to a common positive electrode (not shown).

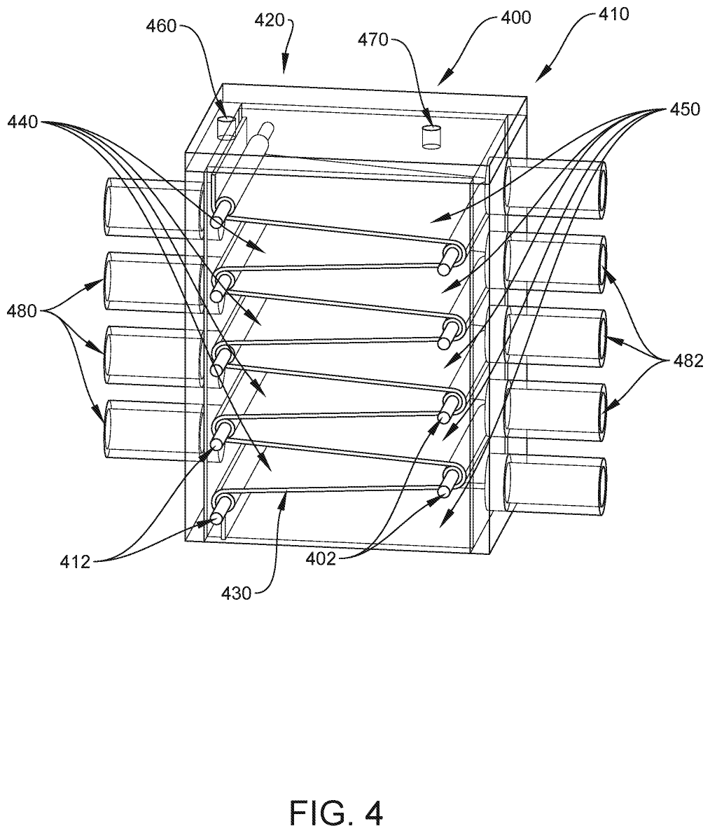

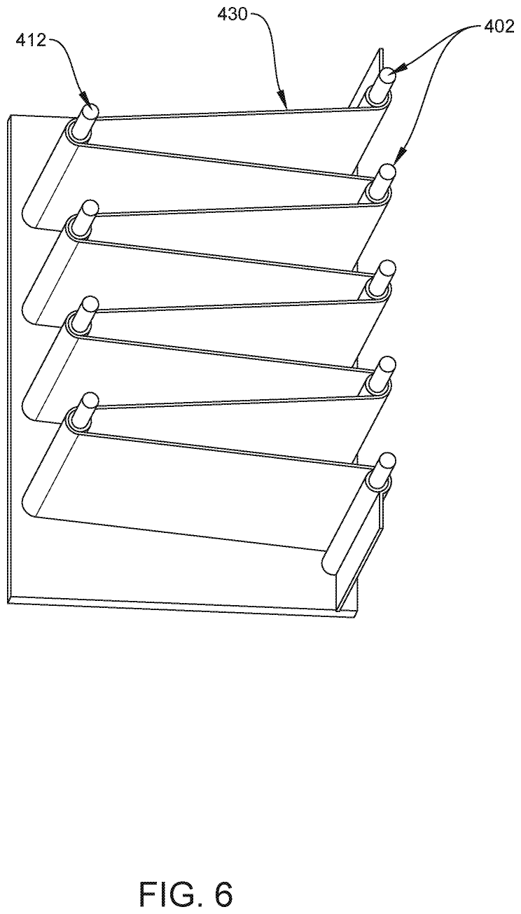

Another embodiment of a Li Ion battery of the present invention is shown in FIGS. 4-6. In this embodiment, as shown in FIG. 4, a housing 400 supports a set of pins 402, 412 (more clearly shown in FIG. 6). The pins 402 on the one side 410 of the housing are staggered relative to the pins 412 on the other side 420 of the housing. This allows a porous membrane 430, e.g., a porous polymer membrane (see also FIG. 6) to be wound around the pins 402, 412 to form wedge-shaped structures within the housing 400.

The wedges 440 with their wide section toward the left-hand side of the housing 400 as depicted in FIG. 4 define anode housings and are filled with granular SiO2 to form wedge-shaped anodes. The granular SiO2 is also referred to herein as SiO2 nanoparticles since the grain structure is typically in the nanometer range.

The intervening wedges 450 with their wide end facing the right-hand side in FIG. 4, define cathode housings and are filled with cathode material as known in the art, to define wedge-shaped cathodes. In practice the wedge-shaped anodes are connected to together to define the anode of the battery, and are electrically connected to an anode electrode (negative electrode) depicted by electrode 460. The wedge-shaped cathodes are connected to together to define the cathode of the battery, and are electrically connected to a cathode electrode (positive electrode) depicted by electrode 470.

In this embodiment, cylindrical expansion chambers 480, 482 extend from the housing 400. The expansion chambers are aligned with the wide ends of the wedge-shaped anodes and cathodes and are in flow communication with the anode and cathode material, respectively so that expansion of the anode material (SiO2) will allow the material to expand into the chambers 480. Since the porous membrane 430 in this embodiment is flexible, pressure exerted laterally by expanding SiO2 particles can cause pressure on the cathode material. Hence the wedge-shaped cathodes 450 are also provided with expansion chambers 482 to allow flowable (e.g., particularized or granular) cathode material to be displaced from the wedge-shaped cathodes 450 in the housing 400 into the expansion chambers 482. As in the embodiment of FIG. 1, the expansion chambers 480, 482 (also referred to herein as expansion regions or expansion means) are cylindrical in shape to accommodate pistons (not shown). Preferably the pistons in this embodiment and the FIG. 1 embodiment are attached to springs that compress as the pistons move outward, thereby urging the pistons to move back inward, toward the housing 400 when the SiO2 material contracts.

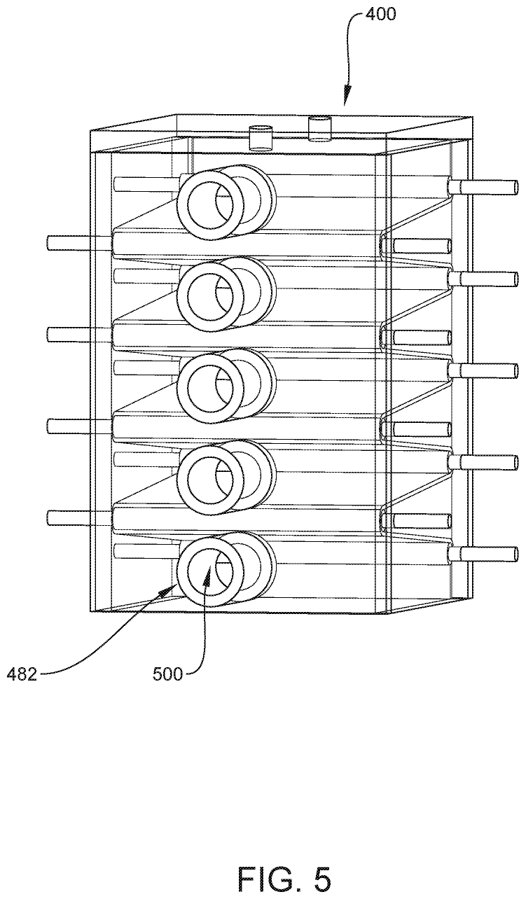

FIG. 5 shows the housing 400 from the cathode end, showing the pistons 500 inside the expansion chambers 482. For clarity, the compression springs in the expansion chambers 482 are not shown, nor are the end caps that in practice cover the outer openings of the expansion chambers 482. The end caps, which cover the openings of the expansion chambers 482 when fully assembled, provide a surface for the compression springs to act against.

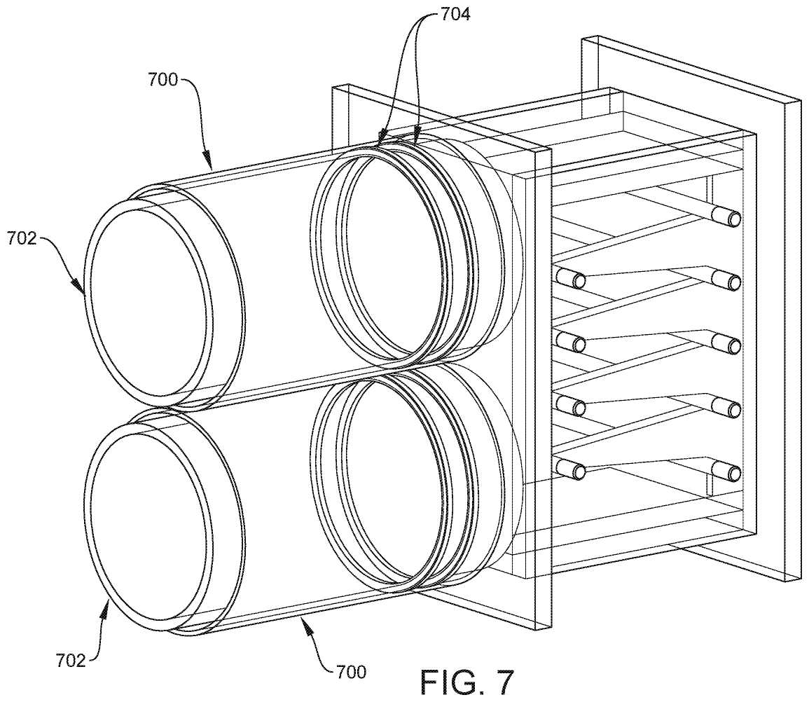

A variation of the FIG. 4 embodiment is shown in FIG. 7. In this embodiment, only the anode is provided with expansion chambers or expansion regions 700, and only two such regions are provided. Each expansion chamber 700 is provided with a piston 702 having O-rings 704 to provide a slidable seal between chamber wall and piston.

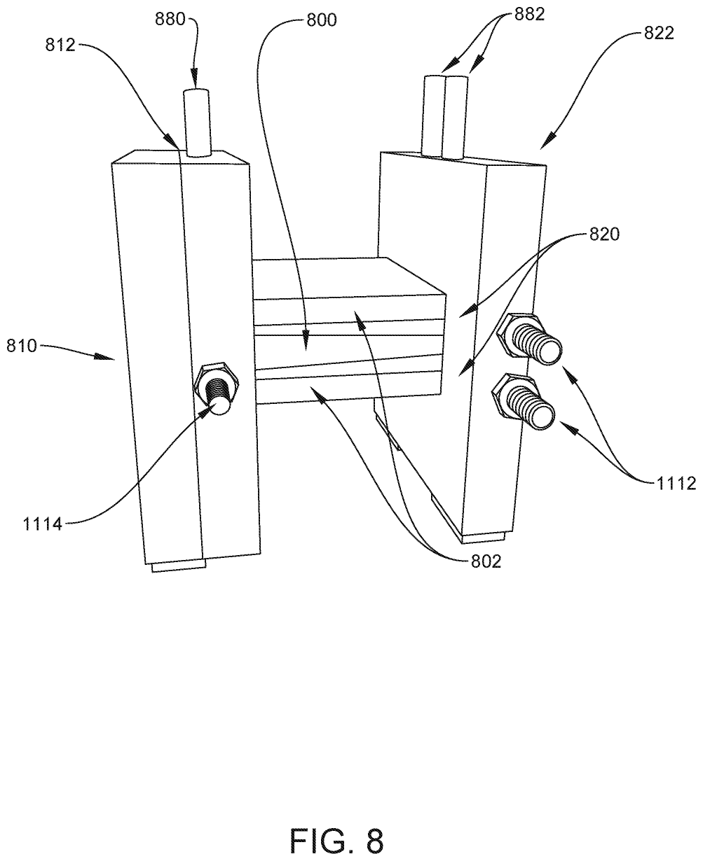

Yet another embodiment of a Li Ion battery of the present invention is shown in FIGS. 8-16. Again, this embodiment makes use of wedge-shaped anodes and cathodes, but in this case the wedge-shaped housings are not formed of a flexible membrane but are formed from a more rigid plastics material that is nevertheless porous for the passing of ions between the anode and cathodes. In the embodiment shown in FIG. 8, a single wedge-shaped anode housing 800 is shown wedged between two wedge-shaped cathode housings 802. Again, the wide side of the anode includes expansion means, indicated generally by reference numeral 810. In this embodiment, the expansion means comprises a termination wall 812, shown more clearly in FIG. 9. The termination wall 812 includes a central opening 900 and a concave recess 902 flaring outwardly from the opening 900. The opening 900 is in flow communication with the particulate SiO2 material that once again defines the anode and is housed in the anode housing 800. Thus, during expansion of the SiO2 material, the SiO2 particles can extend into and through the opening 900, passing into the concave recess region 902.

Also shown in FIG. 9 is a copper current collector mesh 910 for the anode, which will be discussed further below.

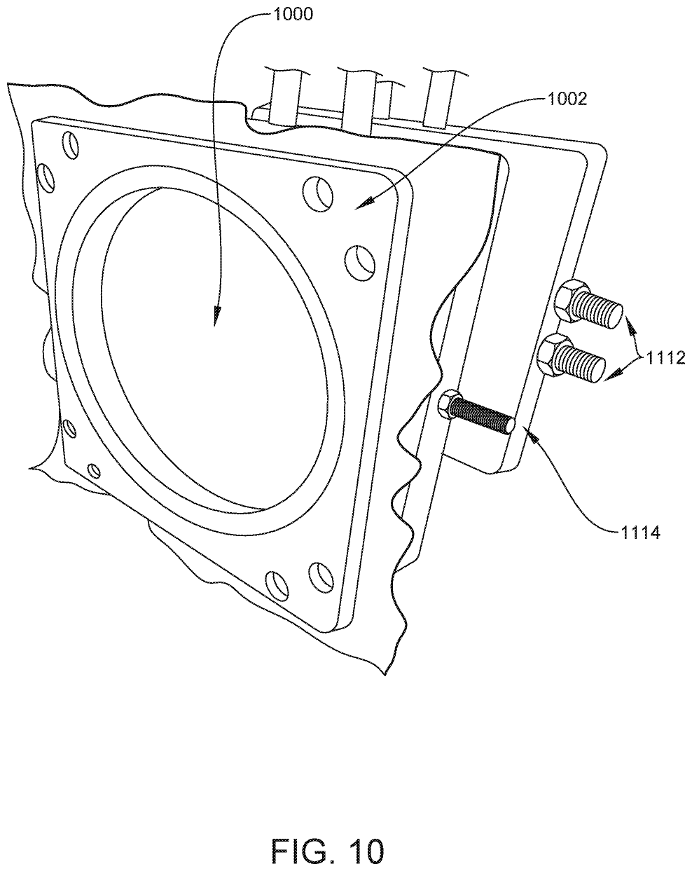

As shown in FIG. 10, a flexible membrane 1000 is used to cover the outer open end of the concave recess region 902, and is secured by means of a mounting bracket 1002. The flexible membrane 1000, e.g. a latex membrane, permits additional expansion of the anode material and also provides a compressive force on the expanding material to urge it back into the anode housing when the SiO2 contracts.

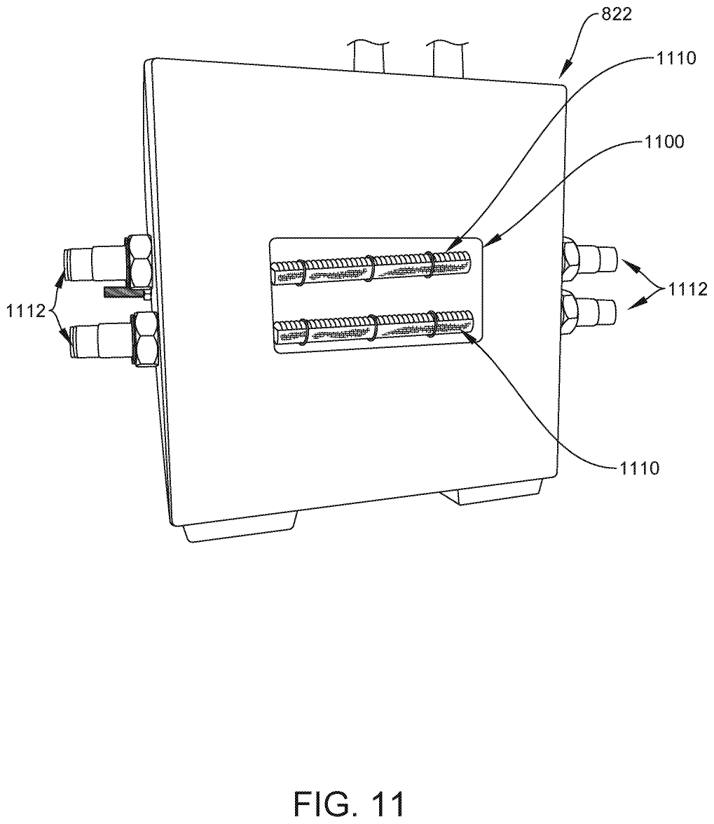

The wide ends 820 of the wedge-shaped cathode housings 802 are also provided with a terminating wall 822. FIG. 11 shows an end view of the cathode terminating wall 822. In this case the wall 822 presents a rectangular opening 1100, which in practice is covered by a cover (not shown).

As shown in FIG. 11, each cathode is provided with a mesh 1110, which in this case takes the form of aluminum meshes, acting as current collectors that are electrically connected to positive electrodes 1112.

The anode is also provided with a current collector (depicted in FIG. 9 by reference numeral 910), which in this case is defined by a copper mesh and is shown more clearly in FIG. 16. The copper mesh 910 electrically connects to a negative electrode, which is depicted in FIGS. 8 and 10 by reference numeral 1114.

FIGS. 12 to 15 provide a more detailed view of the wedge-shaped anode and cathode housings. The anode housing 800 (shown here in black) has a square horse-shoe configuration as shown in FIG. 12. The cathode housings 820 (one of which is shown here in white) similarly have a square horse-shoe configuration. Each wedge-shaped housing 800, 802, thus defines a central wedge-shaped space 1200 for housing either anode material (SiO2 in this case) or cathode material.

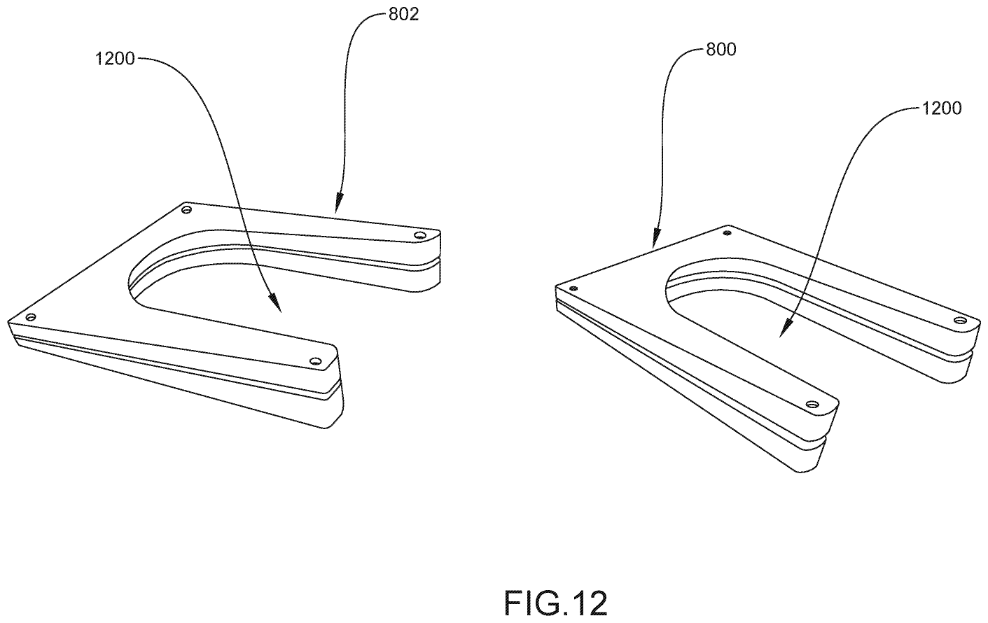

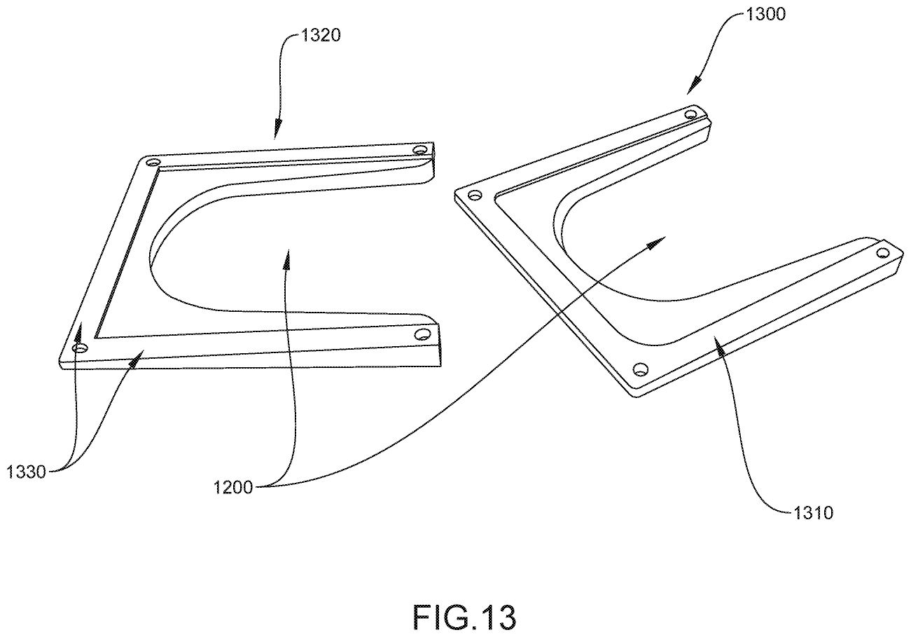

Furthermore, the anode wedge-shaped housing 800 is made up of two sections (one of them is shown in FIG. 13 and depicted by reference numeral 1300). The section 1300 has an outer peripheral lip 1310 so that when two such sections are placed face-to-face, they form a space between them that is open toward the central horse-shoe space 1200. This space between the two sections receives the copper current collector mesh of the anode. Each cathode housing 802 is similarly made up of two sections, one of which is depicted by reference numeral 1320 in FIG. 13, and again has a peripheral lip 1330. Again, the lip 1330 forms a space, which in this case receives the aluminum current collector mesh for the cathode.

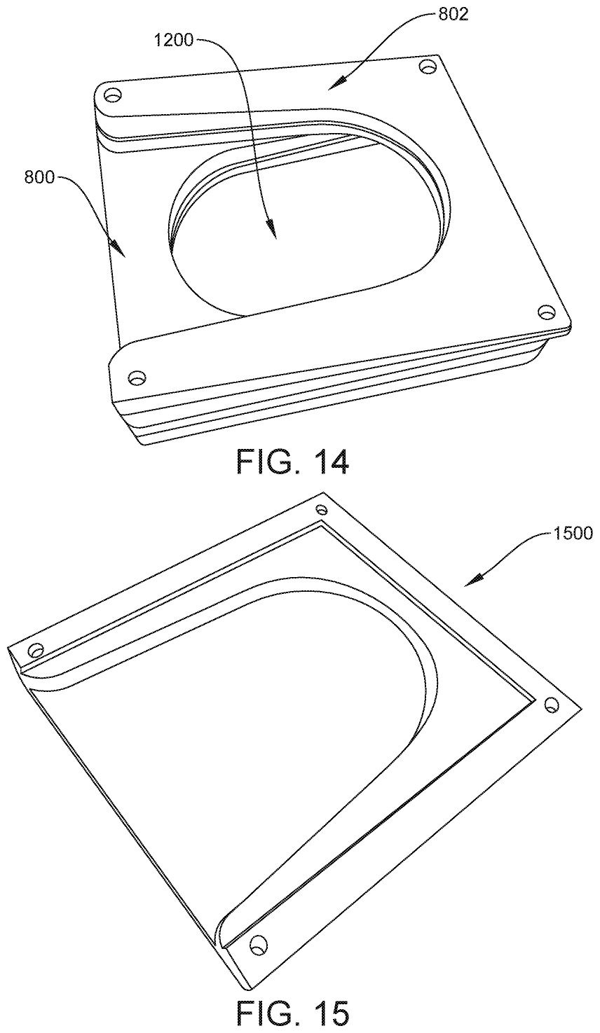

FIG. 14 shows the anode housing 800 and one of the cathode housings 802 stacked on top of one another, as they would when being assembled to form a battery. In order to seal the central openings 1200 of the cathode horse-shoe structures, the top and bottom cathode housings 802 are sealed by means of top and bottom end caps 1500 as shown in FIG. 15.

As shown in FIG. 16, the anode housing 800 is separated from the cathode housings 802 by separators 1600, which comprise permeable membranes. The copper mesh 910 of the anode, and the aluminum mesh 1110 of each cathode, are also shown in FIG. 16. It will be appreciated that FIG. 16 shows the battery inverted compared to the depiction in FIG. 8. Thus, the end wall 812 on the wide side of the anode housing is on the right-hand side in this Figure, and the end wall 822 on the wide sides of the cathode housings is on the left side. The end wall 812 also shows the concave recess 902 with the central opening 902, as well as the flexible membrane 1000.

Referring again to FIG. 8, the battery in this embodiment includes air vent 880 for venting accumulated gas build up from the anode, and air vents 882 for venting accumulated gas build up from the cathodes.

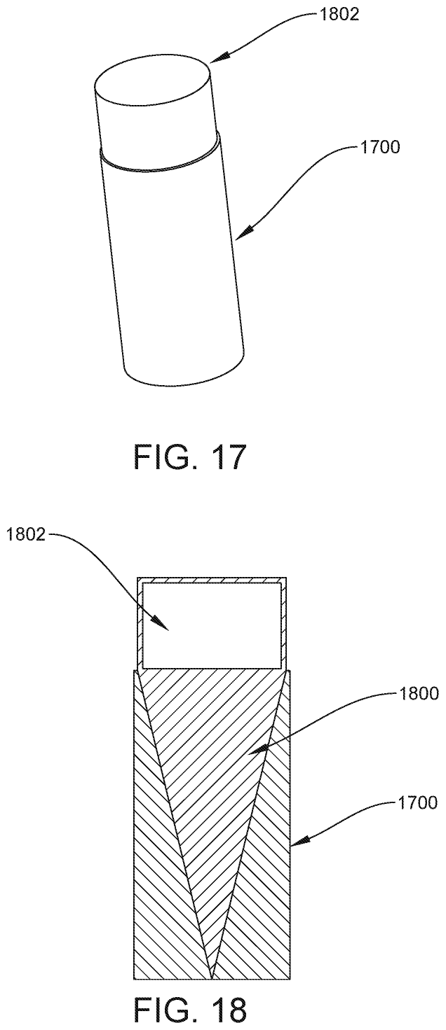

Yet another embodiment of a Lithium Ion battery of the present invention is shown in FIGS. 17 and 18. In this embodiment, the cathode 1700 is formed from a solid material and shaped into a cylinder. As shown in the cross-section of FIG. 18, the cathode 1700 is provided with a conical cavity, which defines an anode housing and receives the particulate anode material (SiO2 in the present invention) to define the anode 1800. The anode 1800 is provided with an expansion chamber 1802, so that the SiO2 can expand into the expansion chamber. The expansion chamber 1802 can again be provided with a spring and piston arrangement (not shown) as discussed above with respect to the FIG. 4 and FIG. 7 embodiments.

While the present invention has been described with respect to specific embodiments, it will be appreciated that other configurations of the battery can be produced, without departing from the scope of the invention.

What is claimed is:

1. A battery, comprising
an anode,
a cathode, and
a separator between the anode and the cathode, wherein the anode is made of particularized Silicon Dioxide (SiO2) and includes means for accommodating the expansion of the SiO2.

2. A battery of claim 1, wherein the SiO2 includes nanoparticles contained in one or more housings to define one or more anodes interspersed between, or place in proximity with one or more cathodes, or formed within a cathode to form one or more cells of the battery.

3. A battery of claim 2, wherein the anodes, each comprise SiO2 anode material retained in an anode housing, wherein the anodes are electrically connected to each other.

4. A battery of claim 2, wherein the battery includes multiple cathodes interspersed or otherwise placed in proximity with the anodes, and electrically connected to each other.

5. A battery of claim 2, wherein each cathode comprises a solid cathode material shaped to define an anode housing.

6. A battery of claim 5, wherein the cathode is substantially cylindrical with a conical cavity for receiving granular anode material.

7. A battery of claim 6, wherein the granular anode material includes SiO2.

8. A battery of claim 6, wherein an expansion region is provided at the wide end of the conical cavity.

9. A battery of claim 2, wherein each anode is electrically connected to an anode current collector, and each cathode is electrically connected to a cathode current collector.

10. A battery of claim 9, wherein the anode current collector comprises a copper mesh, and in the cathode current collector comprises an aluminum mesh.

11. A battery of claim 10, wherein the anode material is compressed in its anode housings.

12. A battery of claim 2, wherein the housings containing the SiO2 particles have angled walls.

13. A battery of claim 12, wherein the walls of each housing containing the SiO2 particles defines a wedge-shaped or cone-shaped anode housing.

14. A battery of claim 2, wherein the anode and cathode housings are defined by one or more porous separators.

15. A battery of claim 2, wherein the anode and cathode housings each comprise individual structures that each includes a current collector.

16. A battery of claim 15, wherein the anode housings and cathode housings are alternatingly stacked together.

17. A battery of claim 12, wherein each anode housing or group of anode housings includes an expansion region or is connected to an expansion means.

18. A battery of claim 17, wherein the expansion region is integrally formed with the anode housing.

19. A battery of claim 18, wherein the expansion means defines a separate housing in flow communication with the anode housing to allow SiO2 particles to flow into the expansion means.

20. A battery of claim 17, wherein the expansion region includes a cylindrical housing with a piston, or a housing with a flexible wall, to accommodate expansion of SiO2 particles.

21. A battery of claim 17, wherein the expansion means includes a flexible membrane covering an opening in the anode housing.

22. A battery of claim 17, wherein the angled walls of each anode housing defines a wide end, and one or more expansion regions or expansion means are located at the wide end of each anode housing.
